(19) United States
(12) Patent Application Publication
(10) Pub. No.: US 2009/0325007 A1
(43) Pub. Date: Dec. 31, 2009

(54) CONTROL OF PARALLELED FUEL CELL ASSEMBLIES

(76) Inventors: Rishi Grover, Manchester, CT (US); Steven J. Fredette, South Windsor, CT (US); George Vartanian, Ellington, CT (US)

Correspondence Address: M.P. Williams, 210 Main Street, Manchester, CT, 06042, US

(21) Appl. No.: 12/448,656

(22) PCT Filed: Dec. 29, 2006
(86) PCT No.: PCT/US06/49639

§ 371 Date: Jun. 29, 2009

(51) Int. Cl. H01M 8/00; H01M 8/04

(52) U.S. Cl. 429/13; 429/22; 429/25

(57) ABSTRACT

Fuel cell stack assemblies (15, 16) connected in parallel through related power control portions (39, 40; 60, 61) of a system power converter (41) supply power to a common grid (22) or non-grid load (58) on an equal or near-equal current basis. Power command to one portion is one-half the total power (P*) minus a function (46) of the difference (45) in current from the stack assemblies. The other portion power command (P1*) for a utility grid (22) is the difference between the total power and the power command (P2*) to the first stack assembly. For a non-grid load, one portion (61) controls the load voltage, the other portion command (P2*) causes substantially equal currents. Altering (33b) actual current signals results in the cell stack assemblies providing different currents. A failed stack assembly is disconnected from the load and reactant; the non-failed assembly having an appropriate power command.

### TECHNICAL FIELD

Current and fuel utilization are controlled within paralleled fuel cell assemblies, each comprising one or a string of fuel cell stacks, and a reduced number of fuel cell stacks is used should one stack fail.

### BACKGROUND ART

An important parameter in the operation of fuel cell power plants is the efficiency, that is, the degree to which fuel supplied to the fuel cell stack (or stacks) is actually utilized. For any given current, there is a stoichiometric amount of fuel which is consumed in order to generate that current. Fluctuations in power demand are handled in part by adjusting the amount of fuel provided to the fuel cell: larger demand requires more fuel and reduced demand requires less fuel. Attempts to control fuel utilization to exactly the stoichiometric quantity (100% utilization) for maximum efficiency will always result in some parts of at least some cells in a stack suffering fuel starvation. Fuel starvation causes instantaneous performance losses, and more importantly causes permanent decay of cell performance. Typically, fuel utilizations are selected to be on the order of about 85%, to ensure that increased power transients and flow variations will not result in fuel starvation.

Because of the difficulties of controlling reactant gas flows into large numbers of fuel cells, there are practical limits to fuel cell stack sizes, which limits the power obtainable from a single stack. Therefore, assemblies of fuel cell stacks are utilized to provide adequate power. It is desirable to satisfy the need for high fuel utilization without the risk of fuel starvation, even in multiple fuel cell stack assemblies.

A simple arrangement could be to have all of the stacks in series, whereby the same current would flow through all of them. If a serial fuel cell arrangement were utilized, fuel depletion could easily result in extremely high fuel utilization at the downward end of the fuel flow, resulting in possible starvation and performance decay. Furthermore, serial fuel cell stacks could result in a higher voltage than is practicable in any particular circumstance.

As used herein, the terms “fuel cell stack assembly” and “stack assembly” mean (a) a single fuel cell stack, or (b) a string of fuel cell stacks electrically connected in serial voltage relationship.

In FIG. 1, a fuel cell power plant 13 includes among other things, a first fuel cell stack assembly 15 and a second fuel cell stack assembly 16 which are supplied reactant gases in a conventional manner (not shown). The two fuel cell stack assemblies are electrically connected in parallel, separated only by isolation diodes 18, 19. The stack assembly currents are fed to a common power converter 20 which converts the DC current to an appropriate AC voltage, at a correct frequency and phase to suit a power grid 22.

When fuel cell stack assemblies 15, 16 are connected in parallel passively, such as by simply using isolation diodes 18, 19 as shown in FIG. 1, each of the stack assemblies is forced to operate at the same voltage as the other stack assembly, while the current in each stack assembly varies to meet the corresponding operating point of the performance characteristic curve 24, 26 (voltage vs. current) of that stack assembly, as shown in FIG. 2a.

As illustrated in FIG. 2b, if two fuel cell stack assemblies, which are to be interconnected, operate at the same DC current, their voltages are likely to be different since each one has a different performance curve. Parallel stack assemblies with different voltages due to the differing performance curves cannot be passively connected as illustrated in FIG. 1.

In the manufacture of fuel cell stack assembly components, component manufacturing tolerances result in each fuel cell stack assembly having different operational and performance characteristics. The reactant flow pressure drops and therefore reactant flow distributions will vary from one stack assembly to another. Variations carry over to performance so that no two fuel cell stack assemblies have exactly the same performance curve and the same fuel utilization at any point of operation.

As the load on a fuel cell stack or string of stacks varies, the reactants are adjusted in a predetermined relative manner. If separate fuel control valves are used for each stack or string of stacks, each stack or string will have its own feedback loop, with its own time of response and gain. Although the fuel control valve of each stack or string of stacks in a stack assembly could be tuned to provide the correct fuel for any given load in steady-state operation, during transients, a change of fuel and current in one stack or string will interact with changes in fuel commands to other stacks or strings. The result is a very complex control with less than adequate results. If a single fuel control valve is used for all stacks and strings in a fuel cell assembly, trimming may be accomplished to some extent by adjusting reactant flows so as to achieve, at a design point of operation, either the same current, or the same utilization. However, operation off the design point will generally result in variations in the controlled parameter (utilization or current) from one stack or string to another.

After many hours of operation, the performance of one fuel cell may differ from another fuel cell, and reactant flow distribution in the fuel cell stacks may change non-uniformly, which may alter the amount of fuel provided to each stack as well as the thermal distribution within each stack, which in turn can vary the operating point on the performance curve as well as the utilization of fuel in the different stacks.

Controlling fuel flow as a function of measured fuel utilization requires the use of hydrogen sensors at the exit of each stack (or string of series stacks), as well as separate fuel inlet mass flow control and manifolds for each stack or string. Hydrogen detectors are not sufficiently reliable, particularly over thousands of hours of operation, to maintain a desired high utilization without likelihood of fuel starvation.

Another issue with multiple fuel cell stacks is the increased probability for a stack assembly failure. The increased probability causes a drop in power plant reliability. Therefore, what is also needed is a way to avoid this decrease in power plant reliability.

### SUMMARY

A primary predication of the improvements disclosed herein is that control over the balancing of current and therefore fuel utilization in paralleled fuel cell stack assemblies should be accomplished electrically, rather than by mechanical control over reactant flows. Another predication is that assemblies of fuel cell stacks should be configured and connected in such a way as to permit use of assemblies that remain operational, should failure of one of them occur.

A first aspect of the disclosed improvements is the provision of two electrical control philosophies which will readily provide control over fuel cell stacks so as to achieve a more nearly balanced and desired fuel utilization. In a first control philosophy, paralleled fuel cell stack assemblies having different reactant flow, thermal flow and/or performance variations are compensated for by adjusting the current of both fuel cell stack assemblies to be equal. In another control philosophy, the current of paralleled fuel cell stack assemblies is adjusted to be proportional to the fuel cell's ability to contribute to the required load.

Control schemes are provided for compensation of paralleled fuel cell stack assemblies when the assemblies are connected to a grid, and therefore must respond as current sources, as well as for when the fuel cell assemblies are independent of a grid, operating an isolated load.

Embodiments include reactant flow isolation capability and electrical isolation capability so as to permit isolating a failed fuel cell stack assembly while continuing to extract power output from a functional fuel cell stack assembly, even though the total power output is reduced.

Other improvements, features and advantages will become more apparent in the light of the following detailed description of exemplary embodiments, as illustrated in the accompanying drawings.

### BRIEF DESCRIPTION OF THE DRAWINGS

FIG. 1 is a simplified schematic diagram of passively paralleled fuel cell stack assemblies.

FIG. 2a is a voltage/current curve illustrating two fuel cell stack assemblies operating at the same voltage.

FIG. 2b is a voltage/current curve illustrating two fuel cell stack assemblies operating at the same current.

FIG. 3 is a schematic block diagram of control over paralleled current-sharing fuel cell stack assemblies connected to a grid.

FIG. 4 is a schematic block diagram of a control scheme for use in the control of FIG. 3.

FIG. 5 is a schematic block diagram of control over paralleled current-sharing fuel cell stack assemblies connected to a load.

FIG. 6 is a schematic block diagram of a control scheme for use in the control of FIG. 5.

FIGS. 7 and 8 are unequal-current alternatives to the equal-current embodiments of FIGS. 4 and 6.

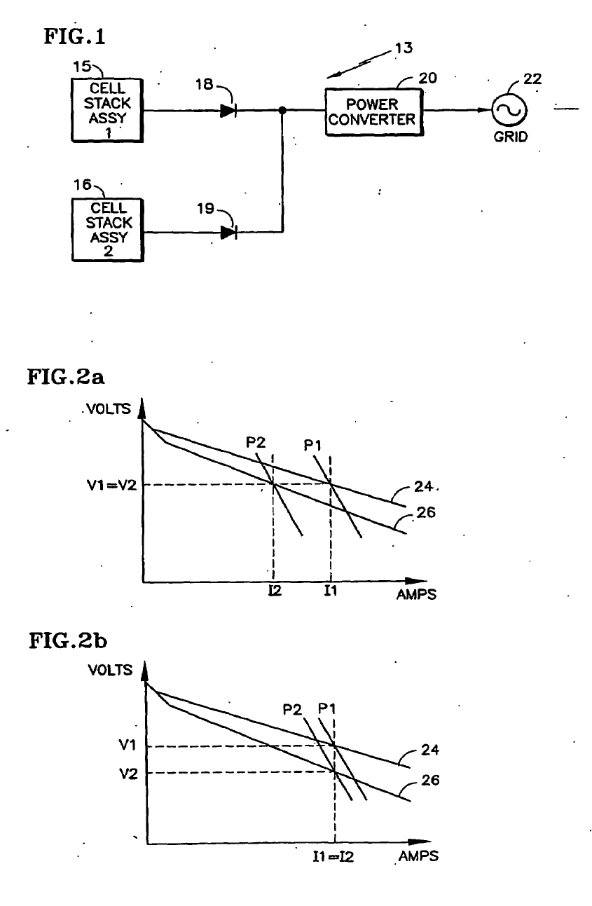

### MODE(S) OF IMPLEMENTATION

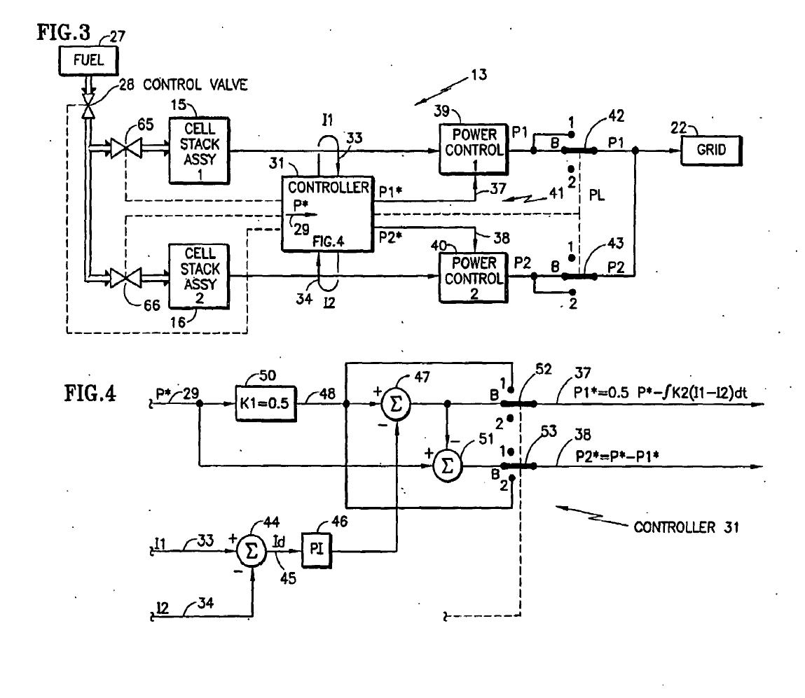

Referring to FIGS. 3 and 4, first and second fuel cell stack assemblies 15, 16 may each comprise an individual fuel cell stack, or a series of two or more fuel cell stacks, within the purview of the embodiments herein. The stack assemblies, in accordance with an important relationship herein, are fed fuel from a source 27 of hydrogen-containing gas through a common fuel control supply, such as a valve 28 responsive to a controller 31.

In order to cause the current of the two fuel cell stack assemblies 15, 16 to be equal, the amount of power supplied by each is adjusted. A desired power setpoint, P*, is established by the controller 31 as represented by a signal on a line 29. The controller 31 may comprise the overall controller of the fuel cell power plant 13 or some other suitable controller. The magnitude of current supplied by each cell stack assembly 15, 16 is provided over corresponding lines 33, 34 to the controller 31, in response to which the controller provides respective power command signals P1*, P2* on corresponding lines 37, 38. These signals are provided to respective power controls 39, 40 which, with the controller 31, comprise a system power converter 41. The converter 41 causes corresponding amounts of power P1, P2, to be provided to the grid 22 (assuming switches 42, 43 are positioned as shown in FIG. 3). The system power converter 41, being connected to the grid which controls voltage accurately, provides whatever current is necessary at that voltage to generate the power indicated by the power setpoint P*.

A related portion of the controller 31 is functionally diagrammed in FIG. 4. Therein, the difference (Id) between the currents (I1, I2) provided by the first cell stack assembly 15 on the line 33 and the second cell stack assembly 16 on the line 34, is provided by a summing junction 44 over a line 45 to a proportional/integral amplifier 46. The output of the proportional/integral amplifier 46 is subtracted, in a summing junction 47 from one-half of the desired power set point, P* on the line 29, which is provided over a line 48 from an amplifier 50. The output of the summing junction 47 is indicated on the line 37 in FIG. 4, assuming switches 52, 53 remain in the positions shown in FIG. 4.

Operation of the controller 31 in FIG. 4 is such that should the current I1 exceed the current I2, a difference signal provided to the proportional/integral amplifier 46 will reduce the amount of the power command for the first power controller 41 (FIG. 3) in proportion to the amount by which the current I1 from the first fuel cell stack assembly 15 exceeds the current I2 from the second fuel cell stack assembly 16. By reducing the amount of power demanded from the first stack, the current provided by the first stack will be reduced, until the two currents are equal. The power command, P2*, for the second fuel cell stack assembly is provided by a summing junction 51 as the difference between the setpoint power, P* and the adjusted power command, P1*. Operation is similar when I2 exceeds I1.

The power commands, P1* and P2* alter the duty cycle in the power control portions 39, 40 of the system power converter 41 in a conventional fashion.

Balancing of the currents can be achieved when the fuel cell power plant 13 is not connected to the grid, but rather is driving a load at a predetermined voltage, as illustrated in FIG. 5. In FIG. 5, the currents I1 and I2 on the lines 33, 34 are fed to a controller 55, along with indications of the power, PL, being drawn by a load 58 such as voltage and current on lines 57. Because the load 58 must be operated at a predetermined voltage, a master controller 61 only controls the voltage provided to the load 58. The controller 61 is a voltage source. On the other hand, a slave controller 60, operating as a current source, controls the power provided by the second fuel cell stack assembly 16 so that the current provided by the second fuel cell stack assembly 16 will be equal to that of the fuel cell stack assembly 15.

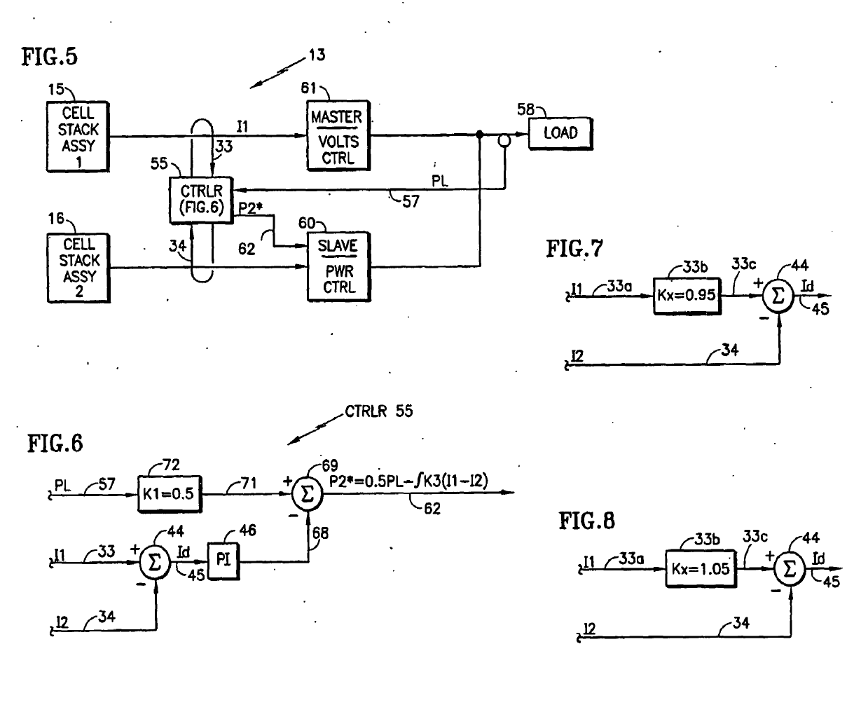

As illustrated in FIG. 6, the portion of the controller 55 related to the control of FIG. 6 includes the summing junction 44 which provides the current difference signal, Id, on a line 45 to the proportional/integral amplifier 46. The output of the amplifier is provided on a line 68 where it is subtracted in a summing junction 69 from a signal on a line 71 provided by an amplifier 72 indicative of one-half of the load power, PL. The resulting power command, P2*, to the slave power controller 60 (FIG. 5) is shown in FIG. 6 on line 62.

The operation in FIGS. 5 and 6 is such that the slave controller will provide current to the voltage controlled load so as to satisfy a power command, P2*, which will cause the current provided by the second cell stack assembly 16 to approach that of the first cell stack assembly 15. Thus, when operating either on the grid or off the grid, the currents can be made substantially equal by the circuitry of FIGS. 3-6.

The embodiments of FIGS. 3-6 control the power supplied by parallel fuel cell assemblies in a manner that the current in the paralleled assemblies will be equal.

Another control scheme which provides improved utilization in paralleled fuel cell stack assemblies causes a current imbalance which is proportional to a nominal operational imbalance between two paralleled fuel cell stack assemblies, with respect to a current required from each cell stack assembly under nominal fuel flow and nominal fuel utilization, in order to meet the power demand. In this alternative form, the paralleled fuel cell assemblies are controlled so that one current may be higher or lower than the other in dependence upon whether that fuel cell assembly provides less or more power, due to reactant flow and temperature variations, and differences in the performance (voltage vs. current) of the respective fuel cell stack assemblies.

Referring to FIG. 7, an example illustrates a case where the first cell stack assembly 15 may produce 5% more power under nominal operating conditions than the second fuel cell stack assembly 16. An amplifier 33b with less than unity gain reduces the sensed current I1 on a line 33a by 5% before applying it over a line 33c to the summing junction 44, while the line 34 passes a signal indicative of the true current magnitude to the summing junction 44. This will cause the circuitry of FIG. 4 or 6 to null the current control with the current I1 actually being 5% greater than the current I2. This in turn will cause cell stack 15 to produce more current than cell stack 2, thereby taking into account that the reactant flow to cell stack 1 is greater than reactant flow to cell stack 2, and/or that the actual fuel utilization in one stack may be higher than that of the other. Use of this aspect tends to mitigate a possibility of flow variations causing one stack to be operated too close to the stoichiometric amount, below which fuel starvation may occur as a result of positive power transients. As shown in FIG. 8, a gain of greater than unity in amplifier 33b accounts for cell stack assembly 2 providing more power than cell stack assembly 1. The gain could be provided on line 34, if desired, instead of on line 33.

Another improvement with respect to multiple fuel cell stack assemblies is illustrated in FIGS. 3 and 4. In FIG. 3, the source of fuel 27 is connected through the common control valve 28 and shut off valves 65, 66 to the respective cell stack assemblies 15, 16. For each stack assembly there is a corresponding switch 42, 43 between the related power control 39, 40 and the grid 22. Similarly, in FIG. 4, there is a switch 52, 53 corresponding to each of the cell stack assemblies 15, 16. In the event that the controller 31 senses that one of the cell stack assemblies is not operating properly, such as by a loss of current, or in response to other condition (which may include temperature sensed in a conventional fashion), the controller is able to shut down one of the cell stack assemblies while at the same time allowing power to be provided to the grid by the other of the cell stack assemblies. As an example, if the first cell stack assembly 15 were to fail, the controller can transfer the switches 42, 43 from B (meaning both, in FIGS. 3 and 4) to 2, meaning the second cell stack assembly 16. At the same time, the switches 52, 53 in FIG. 4 are switched from B to 2, to provide a power command, P2*, to the stack which has not failed. This will cause P1* to be zero and P2* to be equal to one-half of the desired power set point P*. The grid will receive power only from the second cell stack assembly 16, through the power control 40 and switch 43. Similar operation occurs should the controller sense the failure of the first stack.

When the controller senses failure of one of the cell stack assemblies, it will close a corresponding one of a pair of fuel valves 65, 66 to stop the flow of fuel from a source 27 and the related cells of the failed fuel cell stack assembly, as well as blocking the source of oxygen (not shown).

With this innovation, it is possible for a fuel cell stack assembly which has not failed to continue to provide power to the grid, even after failure of one of the fuel cell stack assemblies.

The foregoing disclosure has been presented in the form of schematic, functional block diagrams, illustrating discrete function performing units. Historically, such function performing units may have comprised discrete hardware elements, such as amplifiers, resistive elements at the inputs to amplifiers, capacitors, and the like. However, all of these functions are capable of being performed in conventional computers utilizing known programming techniques. Additionally, although amplifiers 50, 72 are shown multiplying by one-half, they could as well divide by two. Although the switches 42, 43, 52, 53 are illustrated as mechanical switches, electronic switching or computer program routing may also be used.

1. A fuel cell power plant (13) comprising:
a plurality of fuel cell stack assemblies (15, 16) connected in parallel and configured to supply power to a common load (22, 58) in response to at least one reactant supplied thereto;
a source of fuel (27);
characterized by:
a single fuel control supply (28, 31) configured to provide, from said source to each fuel cell stack in said plurality of fuel cell stack assemblies, all of the fuel required by said fuel cell stacks;
a system power converter (41) electrically coupled to said plurality of fuel cell stack assemblies, said system power converter configured to apportion electric power output among said fuel cell stack assemblies to maintain a predetermined electric current level of the fuel cell power plant and an electric output level of the fuel cell power plant selected from (a) power output level and (b) voltage output level; and
means (31, 55; 41; 42, 43; 52, 53) configured to respond to one of said fuel cell stack assemblies having failed (a) to disconnect said failed one of said fuel cell stack assemblies from said common load, and (b) to provide a power command signal to one of said fuel cell stack assemblies which has not failed.

2. A fuel cell power plant (13) comprising:
a plurality of fuel cell stack assemblies (15, 16);
a source of fuel (27);
characterized by:
a single fuel control supply (28, 31) configured to provide, from said source to each fuel cell stack in said plurality of fuel cell stack assemblies, all of the fuel required by said fuel cell stacks; and
a system power converter (41) electrically coupled to said plurality of fuel cell stack assemblies, said system power converter configured to apportion electric power output among said fuel cell stack assemblies to maintain a predetermined electric current level of the fuel cell power plant and an electric output level of the fuel cell power plant selected from (a) power output level and (b) voltage output level.

3. A fuel cell power plant according to claim 2 further characterized in that:
said electric output level is power output level.

4. A fuel cell power plant according to claim 2 further characterized in that:
said electric output level is voltage output level.

5. A fuel cell power plant according to claim 2 further characterized in that:
said system power converter (41) is configured to balance the current output of each of said fuel cell stack assemblies (15, 16) to compensate for one or more variations selected from (a) variations in fuel flow in each of said fuel cell stack assemblies, (b) variations in fuel flow pressure in each of said fuel cell stack assemblies, (c) variations in thermal profile in each of said fuel cell stack assemblies, and (d) variations in performance characteristic of each of said fuel cell stack assemblies.

6. A fuel cell power plant according to claim 5 further characterized in that:
the one or more variations include variations in fuel flow.

7. A fuel cell power plant according to claim 2 further characterized in that:
the one or more variations include variations in fuel flow pressure.

8. A fuel cell power plant according to claim 2 further characterized in that:
the one or more variations include variations in thermal profile.

9. A fuel cell power plant according to claim 2 further characterized in that:
the one or more variations include variations in performance characteristic.

10. A fuel cell power plant (13) according to claim 2 further characterized in that:
said system power converter (41) includes a plurality of power control portions (39, 40), each respectively corresponding to a related one of said fuel cell stack assemblies (15, 16), and means (47, 69) configured to provide to a first one of said power control portions a first power command signal (37, P1*; 62, P2*) as a fraction (50, 72) of a power signal indicative of total power (P*, PL) provided by said plurality of fuel cell assemblies minus a function (46) of the difference (45) in magnitude between a first current (I1, 33) produced by a first one of said fuel cell stack assemblies and a second current (I2, 34) produced by a second one of said fuel cell stack assemblies.

11. A fuel cell power plant (13) according to claim 10 further characterized in that said system power converter (41) comprises:
first means (33, 33c) configured to provide a first current signal related to the magnitude of a first current (I1) produced by a first one of said fuel cell stack assemblies (15, 16);
second means (34) configured to provide a second current signal related to the magnitude of a second current (I2) produced by a second one of said fuel cell stack assemblies;
third means (44) configured to provide a difference signal Id, (45) as a function of the difference in current magnitude indicated by said first and second signals;
fourth means (29, 57) configured to provide a power signal indicative of total power to be provided by said plurality of fuel cell assemblies; and
fifth means (47, 69) configured to provide to a first one of said power control portions (39, 40) said first power command signal (37, P1*; 62, P2*) as a fraction (50, 72) of said power signal minus a function (46) of said difference signal.

12. A fuel cell power plant (13) according to claim 11 further characterized in that:
said fifth means is configured to provide said first power command signal (P1*) as a fraction (50, 72) of said power signal (29, 57) minus (47, 69) a proportional and integral function (46) of said difference signal (45).

13. A fuel cell power plant (13) according to claim 11 further characterized in that:
said fourth means is configured to provide said power signal (29, 57) selected from (a) a signal (P*) indicating a predetermined power set point and (b) a signal (PL) indicating total power actually provided to a non-grid load (58) by said fuel cell stack assemblies (15, 16).

14. A fuel cell power plant (13) according to claim 11 further characterized in that:
said fourth means is configured to provide said power signal (29) indicating a predetermined power set point indicative of total power (P*) to be provided by said plurality of fuel cell stack assemblies (15, 16) to a utility power grid (22); and further comprising:
means (51) configured to provide to a second one of said fuel cell stack assemblies (16, 40) a second power command signal (P2*) as a function of said power signal (P*) minus said first power command signal (P1*).

15. A fuel cell power plant (13) according to claim 11 further characterized in that:
said fourth means is configured to provide said power signal (29) indicative of actual power (PL) provided by said plurality of fuel cell stack assemblies (15, 16) to a non-grid load (58); and
a second one of said power control portions is configured to provide power to said non-grid load in a manner to control the voltage of power supplied to said non-grid load.

16. A fuel cell power plant (13) according to claim 11 further characterized in that:
either said first means (33, 33c) or said second means (34) is configured to provide said first current signal or said second current signal, respectively, indicative of the true current (I2) produced by the corresponding one of said fuel cell stack assemblies (16) and the other of said first means (33c) and said second means is configured to provide the other of said current signals indicative of a large fraction (33b) of the current (I1) produced by the other of said fuel cell stack assemblies (15).

17. A fuel cell power plant according to claim 16 further characterized by:
said large fraction being on the order of 0.95.

18. A fuel cell power plant (13) according to claim 11 further characterized in that:
either said first means (33, 33c) or said second means (34) is configured to provide said first current signal or said second current signal, respectively, indicative of the true current (I2) produced by the corresponding one of said fuel cell stack assemblies (16) and the other of said first means (33c) and said second means is configured to provide the other of said current signals indicative of slightly more than (33b) the current (I1) produced by the other of said fuel cell stack assemblies (15).

19. A fuel cell power plant (13) according to claim 18 further characterized by:
said other of said current signals (33c) is indicative of on the order of 1.05 the current produced by the other (15) of said fuel cell stack assemblies.

20. A fuel cell power plant (13) according to claim 11 further characterized in that:
said fuel cell stack assemblies (15, 16) each comprise a single fuel cell stack.

21. A fuel cell power plant (13) according to claim 11 further characterized in that:
said fuel cell stack assemblies (15, 16) each comprise a series of fuel cell stacks.

22-23. (canceled)

24. A method of connecting (39, 40; 60, 61) a plurality of fuel cell stack assemblies (15, 16) in parallel to supply power to a common load (22, 58) in response to at least one reactant supplied thereto;
characterized by:
providing fuel from a source (27) through a single fuel control supply (28, 31) to each fuel cell stack in said plurality of fuel cell stack assemblies in a fuel cell power plant (13), all of the fuel required by said fuel cell stacks; and
apportioning (41) electric power output among said fuel cell stack assemblies to maintain a predetermined electric current level of the fuel cell power plant and an electric output level of the fuel cell power plant selected from (a) power output level and (b) voltage output level; and
in response to one of said fuel cell stack assemblies having failed (a) disconnecting said failed one of said fuel cell stack assemblies from said common load, and (b) providing a power command signal to one of said fuel cell stack assemblies which has not failed.

25. (canceled)

26. A method according to claim 25 further characterized in that said electric output level is power output level.

27. A method according to claim 25 further characterized in that said electric output level is voltage output level.

28. A method according to claim 25 further characterized by:
balancing the current output of each of said fuel cell stack assemblies to compensate for one or more variations selected from (a) variations in fuel flow in each of said fuel cell stack assemblies, (b) variations in fuel flow pressure in each of said fuel cell stack assemblies, (c) variations in thermal profile in each of said fuel cell stack assemblies, and (d) variations in performance characteristic in each of said fuel cell stack assemblies.

29. A method according to claim 28 further characterized in that:
said one or more variations include variations in fuel flow.

30. A method according to claim 28 further characterized in that:
said one or more variations include variations in fuel flow pressure.

31. A method according to claim 28 further characterized in that:
said one or more variations include variations in thermal profile.

32. A method according to claim 28 further characterized in that:
said one or more variations include variations in performance characteristic.

33. A method according to claim 25 further characterized in that said step of apportioning (41) comprises:
providing (47, 69) a first power command signal (37, P1*; 62, P2*) as a fraction (50, 72) of a power signal (P*, PL) indicative of total power provided by said plurality of fuel cell assemblies (15, 16) minus a function (46) of the difference (45) in magnitude between a first current (11, 33) produced by a first one of said fuel cell stack assemblies and a second current (I2, 34) produced by a second one of said fuel cell stack assemblies.

34. A method according to claim 33 further characterized in that said step of providing a first power command signal comprises:
providing a first current signal (33) related to the magnitude of a first current produced by a first one of said fuel cell stack assemblies (15, 16);
providing a second current signal (34) related to the magnitude of a second current produced by a second one of said fuel cell stack assemblies;
providing a difference signal (45) as a function of the difference in current magnitude indicated by said first and second signals;
providing a power signal (P*, PL) indicative of total power to be provided by said plurality of fuel cell assemblies; and
providing said first power command signal (37, P1*; 62, P2*) as a fraction (50, 72) of said power signal minus a function (46) of said difference signal.

35. A method according to claim 33 further characterized by:
providing said power command signal (31, P1*; 62, P2*) as a fraction (50, 72) of said power signal (29, 57) minus (47, 69) a proportional and integral function (46) of said difference signal (45).

36. A method according to claim 33 further characterized by:
providing said power signal (29, 57) selected from (a) a signal (P*) indicating a predetermined desired power set point and (b) a signal (PL) indicating total power actually provided to a non-grid load by said fuel cell stack assemblies (15, 16).

37. A method according to claim 33 further characterized by:
providing said power signal (29) indicating a predetermined desired power set point indicative of total power (P*) to be provided by said plurality of fuel cell stack assemblies (15, 16) to a utility power grid (22); and
providing to a second one of said fuel cell stack assemblies (16, 40) a second power command signal (P2*) as a function of said power signal (P*) minus said first power command signal (P1*).

38. A method according to claim 33 further characterized by:
providing said power signal (29) indicating total power (PL*) to be provided by said plurality of fuel cell stack assemblies (15, 16) to a non-grid load (58); and
providing power to said non-grid load in a manner to control the voltage of power supplied to said non-grid load.

39. A method according to claim 33 further characterized by:
providing (33, 33c; 34) said first current signal or said second current signal, respectively, indicative of the true current (12) produced by the corresponding one of said fuel cell stack assemblies (16) and providing the other of said current signals indicative of a large fraction (33b) of the current (11) produced by the other of said fuel cell stack assemblies (15).

40. A method according to claim 39 further characterized by:
said large fraction being on the order of 0.95.

41. A method according to claim 33 further characterized by:
providing (33, 33c; 34) said first current signal or said second current signal, respectively, indicative of the true current (12) produced by the corresponding one of said fuel cell stack assemblies (16) and providing the other of said current signals indicative of slightly more than (33b) the current (11) produced by the other of said fuel cell stack assemblies (15).

42. A method according to claim 41 further characterized by:
providing the other of said current signals indicative of on the order of 1.05 (33b) the current produced by the other (15) of said fuel cell stack assemblies.

43-44. (canceled)
